(19) United States
(12) Patent Application Publication
(10) Pub. No.: US 2025/0307210 A1
(43) Pub. Date: Oct. 2, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Takumi HIMENO, Kanagawa (JP)

(73) Assignee: FUJIFILM Business Innovation Corp., Tokyo (JP)

(21) Appl. No.: 18/762,818

(22) Filed: Jul. 3, 2024

(30) Foreign Application Priority Data
Mar. 26, 2024 (JP) 2024-050288

(51) Int. Cl. G06F 16/14

(52) U.S. Cl. CPC G06F 16/156; G06F 16/148

(57) ABSTRACT

An information processing system includes: a processor configured to: accept a search query; acquire file data, which is a search result, by searching a database by using the search query; generate an outline of the file data by using the search query or metadata manually added in advance to the file data; and display the outline of the file data on a display unit.

### CROSS-REFERENCE TO RELATED APPLICATIONS

This application is based on and claims priority under 35 USC 119 from Japanese Patent Application No. 2024-050288 filed Mar. 26, 2024.

### BACKGROUND

### (i) Technical Field

The present disclosure relates to an information processing system, a non-transitory computer readable medium storing an information processing program, and an information processing method.

### (ii) Related Art

JP1995-129605A discloses a document searching apparatus that displays a list of search results not only with a title but also with a summary sentence. The document searching apparatus disclosed in JP1995-129605A includes a storage section in which a plurality of documents are stored, a searching section that performs a search on the documents stored in the storage section, an analysis section that analyzes a structure of a document obtained by the searching section, a summary generation section that generates a summary sentence based on the document structure obtained by the analysis section, a search result presentation section that simultaneously or sequentially presents, in a case where there are a plurality of summary sentences for the document obtained by the summary generation section, the summary sentences, and a selection section that selects one of the summary sentences presented by the search result presentation section, in which a more detailed summary sentence or an original document is presented for the summary sentence selected by the selection section.

JP2023-104183A discloses a program capable of presenting a summary sentence of a searched file. The program disclosed in JP2023-104183A is a program executed by a processor, the program causing the processor to realize a function of generating a summary sentence of a text included in a searching target file, a function of acquiring search information for searching for a file, a function of searching for the file from the searching target file based on the search information, and a function of outputting identification information of identifying the searched file and the summary sentence of the text included in the searched file.

### SUMMARY

As described above, there is a technique of presenting, in a case where a search result of file data is to be presented to a search user, a summary of a content of the searched file data together with the search result. Meanwhile, a case is also assumed in which the summary of the content of the file data does not include information required by the search user. Specifically, since the information required by the search user is different, even in a case where the same summary is uniformly presented to all search users, the information required by the search user may not be included. In such a case, the search user needs to open and check the file data, which is the search result. Therefore, even in a case where the summary of the content of the searched file data is presented to the search user, the search user may obtain only insufficient information.

Aspects of non-limiting embodiments of the present disclosure relate to an information processing system, a non-transitory computer readable medium storing an information processing program, and an information processing method that can present, in a case where a search result of file data is to be presented, information in accordance with a user who executes a search, as compared with a case where common information is presented to each of a plurality of different users.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: accept a search query; acquire file data, which is a search result, by searching a database by using the search query; generate an outline of the file data by using the search query or metadata manually added in advance to the file data; and display the outline of the file data on a display unit.

### BRIEF DESCRIPTION OF THE DRAWINGS

Exemplary embodiment(s) of the present invention will be described in detail based on the following figures, wherein:

FIG. 1 is a diagram illustrating a schematic configuration of a file searching system 10 according to an exemplary embodiment;

FIG. 2 is a block diagram illustrating an example of a hardware configuration of an information processing apparatus and a terminal according to the exemplary embodiment;

FIG. 3 is a block diagram illustrating an example of a functional configuration of the information processing apparatus;

FIG. 4 is a diagram describing metadata added to file data;

FIG. 5 is a diagram describing data manually added in advance and the metadata automatically added;

FIG. 6 is a diagram illustrating an example of a list of a search result;

FIG. 7 is a diagram describing a method for storing a search query;

FIG. 8 is a diagram describing organization data;

FIG. 9 is a diagram describing an outline of file data;

FIG. 10 is a diagram illustrating an example of the outline of the file data;

FIG. 11 is a diagram illustrating an example of a setting screen in a case where the outline of the file data is generated; and

FIG. 12 is a flowchart illustrating an example of a flow of an information process by the information processing apparatus according to the exemplary embodiment.

### DETAILED DESCRIPTION

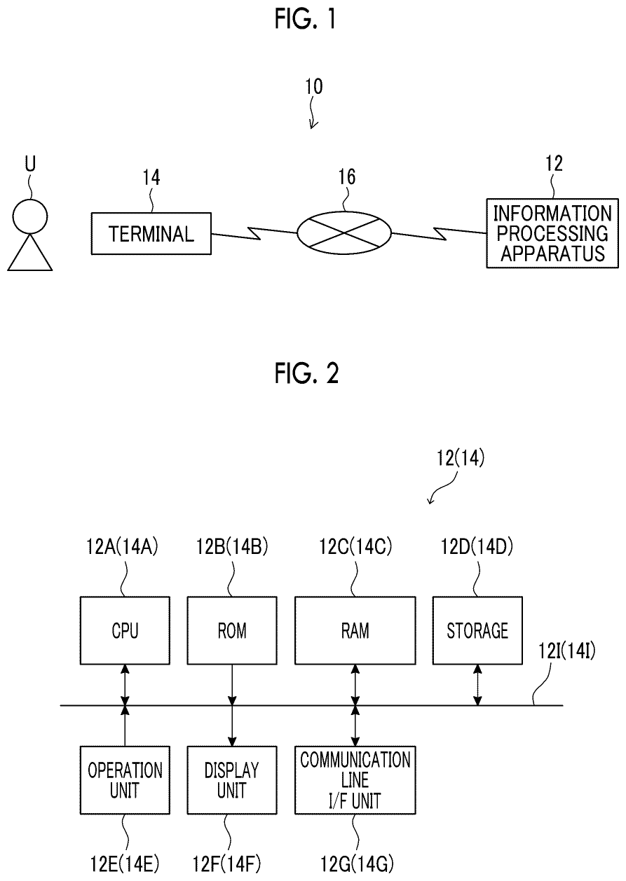

Hereinafter, an example of the present exemplary embodiment will be described in detail with reference to the drawings. In the present exemplary embodiment, a file searching system in which each of a terminal, an information processing apparatus, and the like is connected via a communication line of various types of network or the like will be described as an example. FIG. 1 is a diagram illustrating a schematic configuration of a file searching system 10 according to the present exemplary embodiment.

As illustrated in FIG. 1, the file searching system 10 according to the present exemplary embodiment includes an information processing apparatus 12, a terminal 14, and the like. The information processing apparatus 12 and the terminal 14 are connected to each other via a communication line 16, such as a local area network (LAN), a wide area network (WAN), the Internet, or an intranet. Each of the information processing apparatus 12 and the terminal 14 can transmit and receive various types of data to and from each other via the communication line 16. The information processing apparatus 12 searches for file data stored in a database of the information processing apparatus 12, in response to a request signal transmitted from the terminal 14 of a user U, and outputs a search result to the terminal 14.

In FIG. 1, one information processing apparatus 12 and one terminal 14 are illustrated, and a plurality of each of the information processing apparatus 12 and the terminal 14 may be used or a plurality of any of the information processing apparatus 12 and the terminal 14 may be used.

A main portion configuration of an electric system of the information processing apparatus 12 and the terminal 14 according to the present exemplary embodiment will be described. FIG. 2 is a block diagram illustrating the main portion configuration of the electric system of the information processing apparatus 12 and the terminal 14 in the file searching system 10 according to the present exemplary embodiment. Since the information processing apparatus 12 and the terminal 14 have a general computer configuration, the information processing apparatus 12 will be described below as a representative example.

As illustrated in FIG. 2, the information processing apparatus 12 according to the present exemplary embodiment includes a CPU 12A as an example of a processor, a ROM 12B, a RAM 12C, a storage 12D, an operation unit 12E, a display unit 12F, and a communication line interface (I/F) unit 12G. The CPU 12A controls an operation of the entire information processing apparatus 12. Various control programs, various parameters, and the like are stored in advance in the ROM 12B. The RAM 12C is used as a work area or the like in a case where various programs are executed by the CPU 12A. Various types of data, application programs, and the like are stored in the storage 12D. The operation unit 12E is used to input various types of information. The display unit 12F is used for displaying various types of information. The communication line I/F unit 12G is connected to the communication line 16, and transmits and receives various types of data to and from another apparatus connected to the communication line 16. In addition, the communication line I/F unit 12G may be configured to directly communicate with each device by using various well-known wireless communications. Each unit of the information processing apparatus 12 is electrically connected to each other by a system bus 12I. In the information processing apparatus 12 according to the present exemplary embodiment, the storage 12D is applied as a storage unit, and as an example of a storage, a non-volatile storage unit, such as a hard disk drive (HDD) or a flash memory, is applied.

With such a configuration, in the information processing apparatus 12 according to the present exemplary embodiment, the CPU 12A executes each of an access to the ROM 12B, the RAM 12C, and the storage 12D, acquisition of various types of data via the operation unit 12E, and a display of various types of information on the display unit 12F. In addition, the information processing apparatus 12 executes control of transmitting and receiving communication data via the communication line I/F unit 11G by the CPU 12A.

In the same manner, the terminal 14 according to the present exemplary embodiment executes each of an access to the ROM 14B, the RAM 14C, and the storage 14D, acquisition of various types of data via the operation unit 14E, and a display of various types of information on the display unit 14F by the CPU 14A. Further, the terminal 14 causes the CPU 14A to execute control of the transmission and reception of the communication data via the communication line I/F unit 14G.

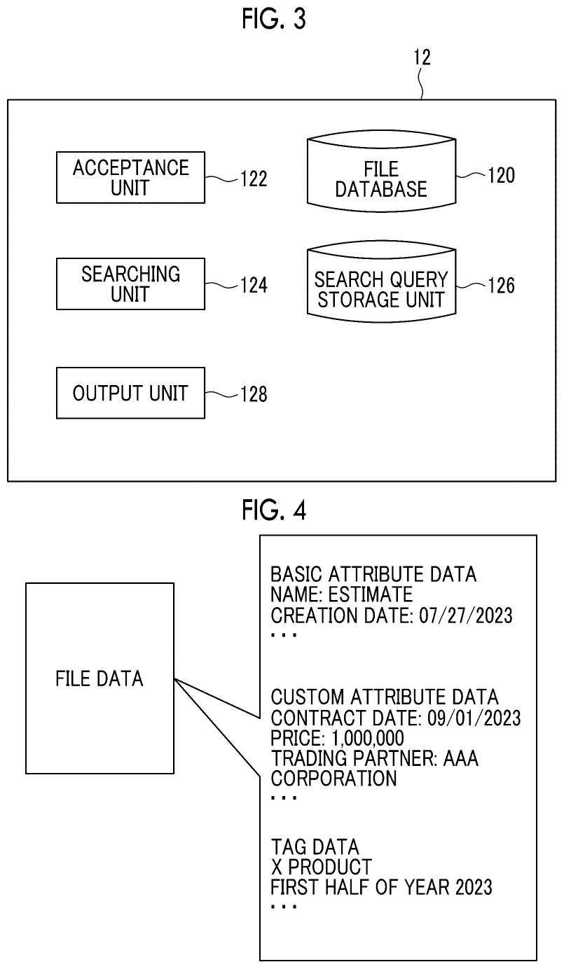

Next, a functional configuration of the information processing apparatus 12 will be described. FIG. 3 is a block diagram illustrating an example of the functional configuration of the information processing apparatus 12.

Functionally, as illustrated in FIG. 3, the information processing apparatus 12 is configured with a file database 120, an acceptance unit 122, a searching unit 124, a search query storage unit 126, and an output unit 128.

The information processing apparatus 12 outputs file data stored in the file database 120, in response to a request signal transmitted from the terminal 14. Specifically, the user U operates the terminal 14 to transmit a request signal for requesting a search to the information processing apparatus 12. In a case where the request signal transmitted from the terminal 14 is accepted, the information processing apparatus 12 searches for the file data stored in the file database 120, and outputs a list of the search result. The information processing apparatus 12 displays the list of the search result, and outputs an outline of the file data included in the list of the search result.

The outline of the file data according to the present exemplary embodiment is not simply a summary of contents of the file data, and includes a search query used in a case of searching for the file data or metadata manually added in advance to the file data. The outline of the file data according to the present exemplary embodiment may include information in which the contents of the file data are summarized.

The file database 120 stores a plurality of pieces of file data. Metadata is added to each of the plurality of pieces of file data.

FIG. 4 is a diagram illustrating metadata added to file data. As illustrated in FIG. 4, for example, basic attribute data, custom attribute data, and tag data are added to the file data as the metadata.

The basic attribute data is, for example, a name and a creation date of the file data. The custom attribute data is, for example, data representing a detailed content of the file data. FIG. 4 illustrates a case where the file data is “an estimate”. In this case, data such as a contract date, a price, or a trading partner which is a content of the estimate, is added to the file data as the custom attribute data. The tag data is various types of data related to the file data. FIG. 4 illustrates a case where the file data is an estimate. For example, data such as a year in which the estimate is created is added to the file data as the tag data.

The metadata added to the file data includes metadata manually added in advance and metadata which is automatically added. In a case where metadata is manually added to file data, a user may create the metadata from scratch (for example, input manually) or may select the metadata from predetermined metadata in advance.

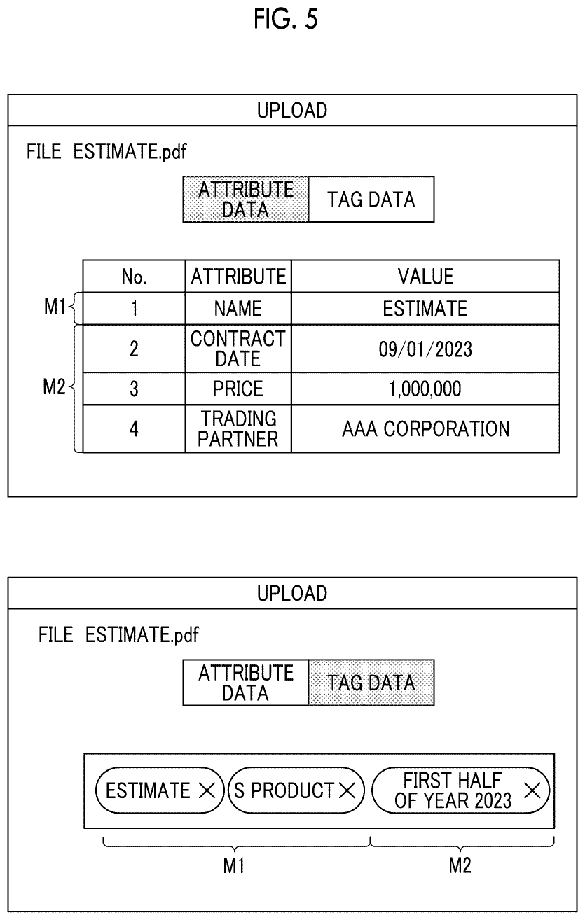

FIG. 5 is a diagram describing data manually added in advance and metadata automatically added. FIG. 5 is an example of a screen displayed on the display unit 14F of the terminal 14 of a user in a case where a file “estimate.pdf” is uploaded to the file database 120.

As illustrated in FIG. 5, for example, a name of file data is automatically added to the file data among attribute data representing basic attribute data and custom attribute data. On the other hand, as illustrated in FIG. 5, among the attribute data representing the basic attribute data and the custom attribute data, for example, a contract date, a price, and a trading partner are manually added to the file data.

In addition, as illustrated in FIG. 5, among tag data, for example, tag data of “first half of year 2023” is manually added to the file data, and tag data of “AAA task” and “estimate” are automatically added to the file data.

These pieces of metadata are used in a case where an outline of the file data is generated. In the following, the metadata which is manually added in advance to the file data is referred to as first metadata, and the metadata which is automatically added to the file data is referred to as second metadata. In the example illustrated in FIG. 5, among the attribute data representing the basic attribute data and the custom attribute data, the “name” of the file is first metadata M1, and the “contract date”, the “price”, and the “trading partner” are second metadata M2. In addition, among the tag data, “estimate” and “S product” are the first metadata M1, and “first half of year 2023” is the second metadata M2.

The acceptance unit 122 accepts a search query input by a user operating the terminal 14. The search query is a word input by the user, a combination of a plurality of words, a sentence, or the like in a case of searching for something using a searching engine.

The searching unit 124 acquires file data, which is a search result, by searching the file database 120 using the search query accepted by the acceptance unit 122.

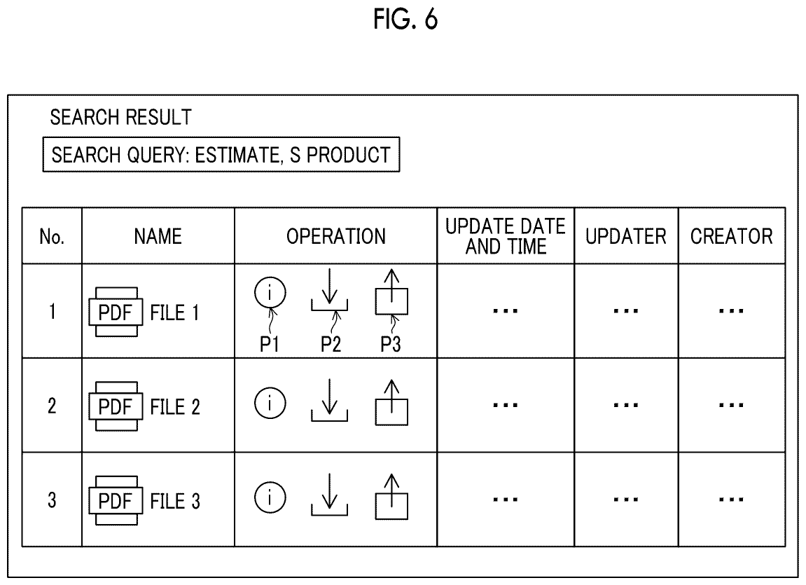

FIG. 6 is a diagram illustrating an example of a list of a search result. As illustrated in FIG. 6, for example, in a case where “estimate” and “S product” are input as a search query, a list of a search result as illustrated in FIG. 6 is displayed. In a case where a cursor is placed at P1 in a field of “operation” of FIG. 6, an outline of file data corresponding to a file 1 is displayed. In addition, by operating P2 in the field of “operation” of FIG. 6, the file data corresponding to the file 1 can be downloaded. In addition, by operating P3 in the field of “operation” of FIG. 6, the file data corresponding to the file 1 can be uploaded.

In addition, the searching unit 124 stores the search query input from a search user in the search query storage unit 126. For example, in a case where a period set in advance elapses from a date and time at which the search query is stored, the search query may be erased from the search query storage unit 126.

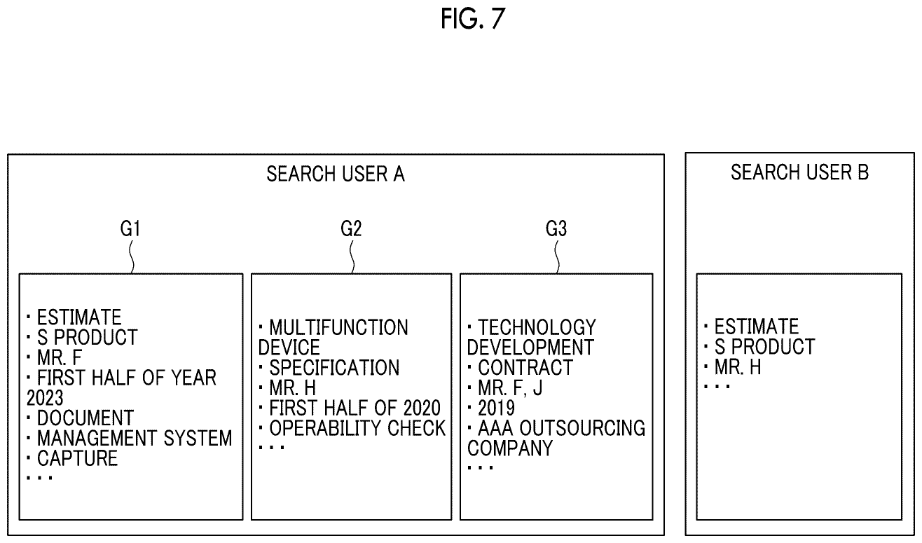

FIG. 7 is a diagram illustrating a method of storing a search query. As illustrated in FIG. 7, the search query is stored in the search query storage unit 126 for each combination of a search user and a group. As illustrated in FIG. 7, a search query input by the search user A and a search query input by the search user B are stored in the search query storage unit 126 in a distinguishable manner. In addition, as illustrated in FIG. 7, the search query of the search user A is stored for each group.

In the present exemplary embodiment, a set of search queries from which similar search results are obtained is a set of search queries belonging to the identical group. For example, in the example illustrated in FIG. 7, a search query “estimate” and a search query “S product” are classified into a group G1. For example, in a case where file data, which is a search result obtained by using the search query “estimate”, is X, Y, and Z, and file data, which is a search result obtained by using the search query “S product”, is X, Y, Z, and W, a similarity degree between X, Y, and Z and X, Y, Z, and W is a value set in advance or more. Therefore, the search query “estimate” and the search query “S product” are classified into the same group A. In a case where the search queries are classified into the identical group, the classification into the group may be performed based on similarity of a notation of the search queries, instead of using similarity of the search results obtained by using the search queries. For example, since a similarity degree of “AAA Corporation” and “AAA Outsourcing Corporation” with respect to the notation is equal to or larger than a value set in advance, “AAA Corporation” and “AAA Outsourcing Corporation” may be classified into the identical group.

The searching unit 124 generates an outline of the file data by using metadata manually added in advance to the file data included in the search query or the search result. For example, the searching unit 124 creates a summary sentence of the file data based on contents of a sentence in the file data and the metadata added to the file data, and generates an outline of the file data by changing the summary sentence based on the search query and other information which will be described below. In a case of generating the outline of the file data, the searching unit 124 generates the outline of the file data to be equal to or less than the number of texts set in advance.

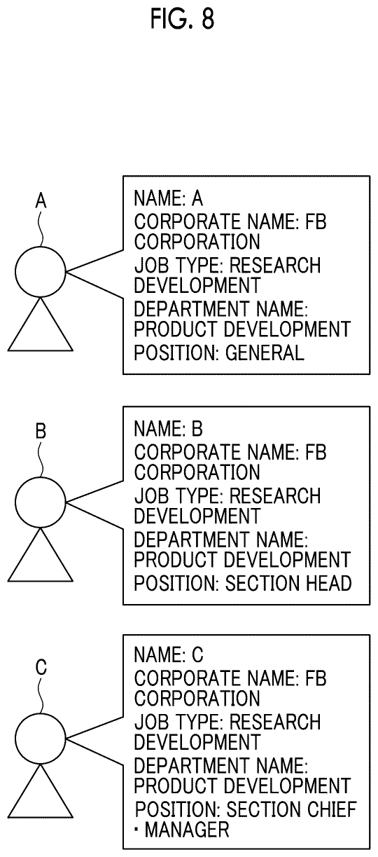

In addition, in a case where person data related to the file data is included in the metadata, the searching unit 124 generates an outline of the file data by using the person data. For example, in a case of generating the outline of the file data using the person data, the searching unit 124 generates the outline of the file data by using organization data to which a person represented by the person data belongs. FIG. 8 is a diagram describing organization data. FIG. 8 illustrates a corporate name, a job type, a department name, and a position to which each of the search user A, the search user B, and a search user C belongs. The organization data illustrated in FIG. 8 is used in a case of generating the outline of the file data described below. For example, in a case of generating an outline of the file data by using the organization data, the searching unit 124 generates the outline of the file data by using a relationship (for example, a superior, a subordinate, or the like) between the search user who inputs the search query and the person data.

Further, the searching unit 124 generates the outline of the file data by using the search query with priority over the metadata.

In addition, in a case where first metadata and second metadata are added to the file data, the searching unit 124 generates the outline of the file data by using the search query with priority over the first metadata and the second metadata.

In addition, in a case where the first metadata and the second metadata are added to the file data, the searching unit 124 generates the outline of the file data by using the first metadata with priority over the second metadata.

In addition, in a case where the search query input by the search user at present is set as a first search query, and a search query which is input by the same search user in the past and classified into a group corresponding to the first search query is set as a second search query, the searching unit 124 generates the outline of the file data by using the second search query.

In addition, in a case where the search query and the metadata added to the file data are the same, the searching unit 124 generates the outline of the file data by using the metadata with priority over other metadata.

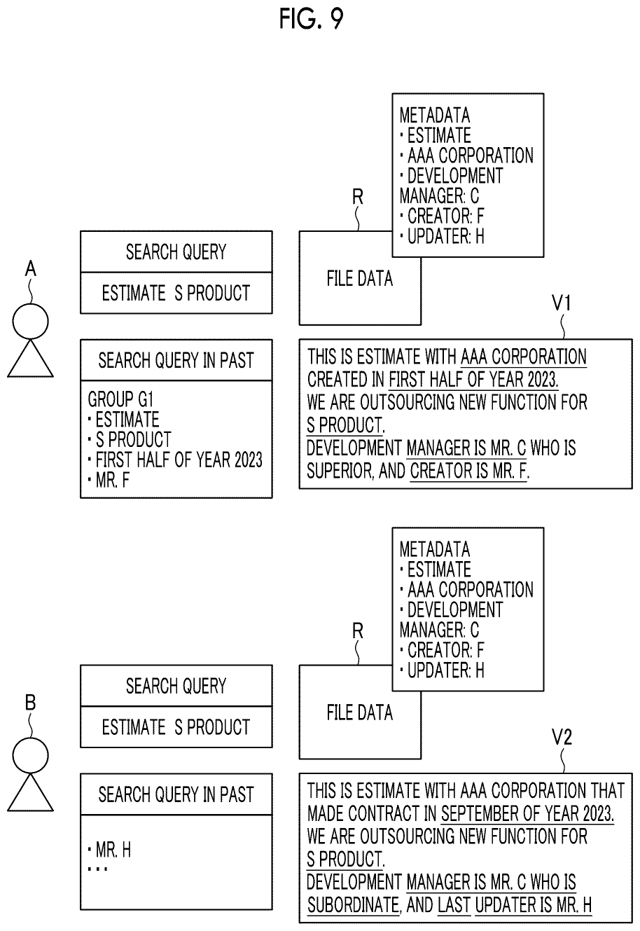

FIG. 9 is a diagram illustrating an outline of file data generated as described above. FIG. 9 illustrates an example of a case where the search user A operates the terminal 14 of the search user A, a search query “estimate” and a search query “S product” are input to the information processing apparatus 12, and file data R is searched by the searching unit 124.

As illustrated in FIG. 9, as an outline V1 of the file data R presented to the search user A, “This is an estimate with AAA Corporation created in first half of year 2023. We are outsourcing anew function for S product. The development manager is Mr. C who is a superior, and the creator is Mr. F” is generated.

As illustrated in FIG. 9, the outline V1 of the file data R includes “estimate” which is a search query, “S product” which is a search query, “AAA Corporation” which is metadata, “Mr. C” which is metadata, and “Mr. F” which is metadata.

In addition, as illustrated in FIG. 9, the outline V1 of the file data R includes a second search query “first half of year 2023” and a second search query “Mr. F” classified into the identical group G1 as the first search query “estimate”.

In addition, as illustrated in FIG. 9, the outline V1 of the file data R includes “Mr. C” which is person data related to the file data R. In the example illustrated in FIG. 9, the outline V1 of the file data is generated by using organization data to which a person “Mr. C” represented by the person data belongs. Specifically, in the example illustrated in FIG. 8, a relationship (for example, a superior, a subordinate, or the like) between the search user A who inputs the search query and the person “C” represented by the person data is used to generate the outline V1 of the file data R. In the example illustrated in FIG. 9, the fact that the person “C” who is a superior of the search user A is the development manager is described in the outline V1 of the file data R.

On the other hand, as illustrated in FIG. 9, an outline V2 of the file data R presented to the search user B is different from the outline V1 of the file data R presented to the search user A. Specifically, as illustrated in FIG. 9, as the outline V2 of the file data R, “This is an estimate with AAA Corporation that made a contract in September of year 2023. We are outsourcing a new function for S product. The development manager is Mr. C who is a subordinate, and the last updater is Mr. H” is generated.

As illustrated in FIG. 9, the outline V2 of the file data R includes “estimate” which is a search query, “S product” which is a search query, “AAA Corporation” which is metadata, and “Mr. C” which is metadata.

As illustrated in FIG. 9, the outline V2 of the file data R includes “Mr. C” which is person data related to the file data R. Also in a case of generating the outline V2 of the file data R, organization data to which the person “C” represented by the person data belongs is used in the same manner as in the generation of the outline V1 of the file data R. Meanwhile, in the example illustrated in FIG. 9, unlike the outline V1 for the search user A, since the search user B executes the search, the fact that the person “C” is a subordinate of the search user B is described in the outline V2 of the file data R.

In addition, in the outline V2 of the file data R, “Mr. H” which is a second search query is described. The “Mr. H” is both the second search query and metadata added to the file data R. Therefore, in a case of generating the outline V2 of the file data R, “Mr. IT” that is the second search query and is the metadata of the file data R is used.

In addition, although not illustrated in the example illustrated in FIG. 9, the search query may be used with priority over the first metadata and the second metadata to generate the outline of the file data. In addition, although not illustrated in the example illustrated in FIG. 9, the first metadata may be used with priority over the second metadata to generate the outline of the file data.

The output unit 128 outputs the outline of the file data generated by the searching unit 124. Specifically, the output unit 128 outputs the outline of the file data to the terminal 14 operated by the search user. The outline of the file data is displayed on the display unit 14F of the terminal 14 operated by the search user.

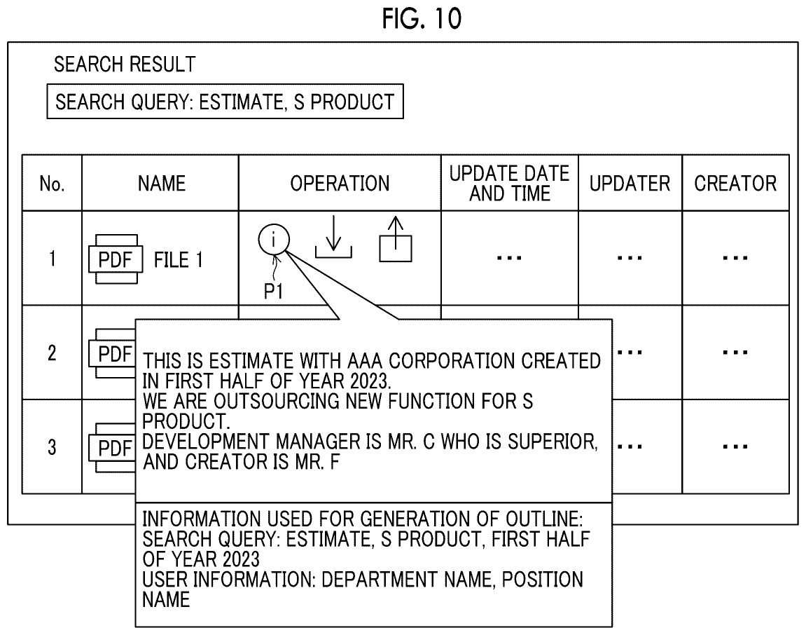

FIG. 10 is a diagram illustrating an example of an outline of file data displayed on the display unit 14F of the terminal 14. As illustrated in FIG. 10, in a case where a cursor is placed on the file data included in a list of a search result, for example, an outline of file data such as “This is an estimate with AAA Corporation created in first half of year 2023. We are outsourcing anew function for S product. The development manager is Mr. C who is a superior, and the creator is Mr. F” is displayed. In this case, as information used for generating the outline of the file data, for example, information such as a search query “estimate, S product, first half of year 2023” and information such as user information “department name, position name” may be presented together.

In addition, in a case where a time set in advance from a creation date and time of the file data, a registration date and time in the file database 120, an update date and time of the file data, or the like elapses and the date and time is old from the current date and time, an alert such as “The creation date and time of the file data, the registration date and time in the file database 120, or the update date and time of the file data is old. Please be careful in a case of referencing this.” may be output together.

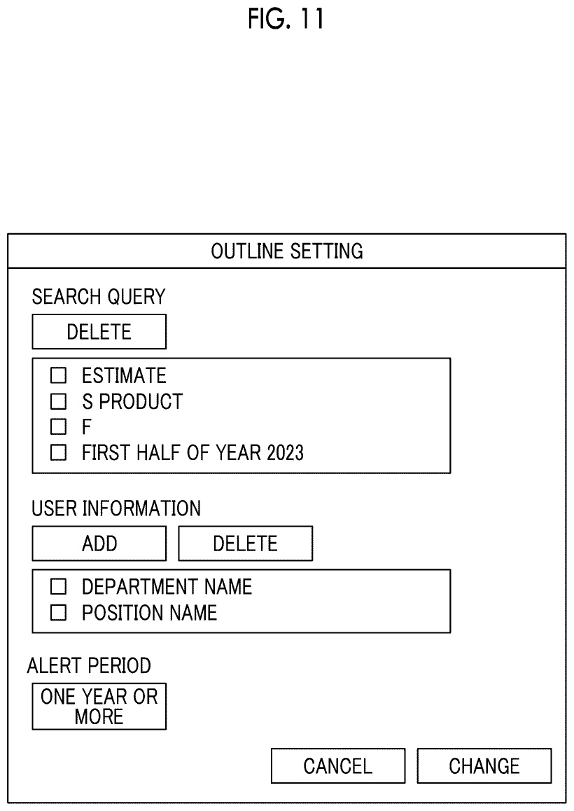

FIG. 11 is a diagram illustrating an example of a setting screen in a case where an outline of file data is generated. The example illustrated in FIG. 11 is an example of the setting screen in a case where the outline for the search user A is generated. As illustrated in FIG. 11, a search query “estimate, S product, F, first half of year 2023” that is a search query used by the search user A in the past and is stored in the search query storage unit 126 is displayed. The search user A can delete the past search query stored in the search query storage unit 126 by operating the screen illustrated in FIG. 11. For example, the search query to be deleted is deleted by checking a check box of the search query to be deleted and pressing a delete button by the search user A.

In addition, the search user A can add or delete organization data of the search user A, by operating the screen illustrated in FIG. 11. For example, the search user A can register a department name and a position name to which the search user A belongs by operating the screen illustrated in FIG. 11. The organization data registered in this manner is used to generate the outline of the file data as described above.

In addition, the search user A can set a period for outputting an alert by operating the screen illustrated in FIG. 11. For example, as described above, in a case where the registration date and time in the file database 120, the update date and time of the file data, or the like is old, it is possible to set a period determined to be old in a case where the alert is output.

It is assumed that metadata to be added to the file data is added to the file data by the file searching system 10 or the user by a uniform method. Therefore, the setting screen related to the generation of the outline as illustrated in FIG. 11 may be set to be un-editable.

Next, a specific process performed by the file searching system 10 according to the present exemplary embodiment configured as described above will be described.

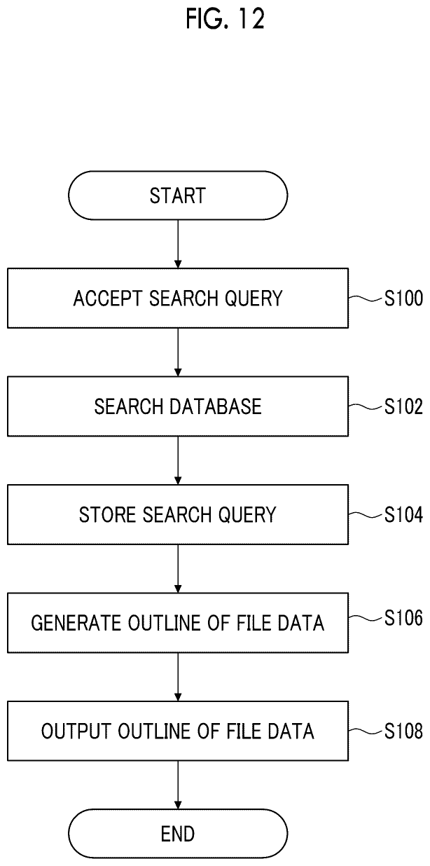

First, in the information processing apparatus 12, the CPU 14A reads an information processing program from the ROM 14B or the storage 14D, develops the information processing program into the RAM 14C, and executes an information process illustrated in FIG. 12.

In step S100, the CPU 14A accepts a search query input by a search user operating the terminal 14 by using the acceptance unit 122.

In step S102, the CPU 14A acquires file data, which is a search result, by searching the file database 120 using the search query accepted in step S100 by using the searching unit 124.

In step S104, the CPU 14A stores the search query accepted in step S100 in the search query storage unit 126 by using the searching unit 124. The searching unit 124 determines which search query of the accepted search queries is the search query input by which search user and which group the accepted search query belongs to, and stores the search query in the search query storage unit 126 in association with a combination of the user and the group in accordance with the determination result. This search query is used to generate an outline of the file data in a case where the identical search user searches the file database 120 next time.

In step S106, the CPU 14A generates the outline of the file data by using a first search query, a second search query, and metadata manually added in advance to the file data included in the search result obtained in step S102, by using the searching unit 124.

In step S108, the CPU 14A outputs the outline of the file data generated in step S106 by using the output unit 128. Specifically, the output unit 128 outputs the outline of the file data to the terminal 14 operated by the search user. The outline of the file data is displayed on the display unit 14F of the terminal 14 operated by the search user.

### Modification Example

The exemplary embodiment of the present invention is not limited to the exemplary embodiment described above, and various modifications and applications are possible without departing from the gist of the exemplary embodiment of the present invention.

For example, first metadata may be added with identification data of a user who adds the first metadata to file data. In this case, in a case where the identification data added to the first metadata indicates a search user who inputs a search query, the searching unit 124 may generate an outline of the file data by using the first metadata added by the search user with priority over first metadata added by a user different from the search user.

In addition, in the exemplary embodiment, the outline of the file data may be generated by using only one of the search query or the metadata manually added to the file data in advance.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the “system” in the present exemplary embodiment is described as an example of a system configured with a plurality of apparatuses, and may be configured with a single apparatus having some of functions of the plurality of apparatuses.

The process performed by the information processing apparatus 12 according to the exemplary embodiment described above may be a process performed by software, a process performed by hardware, or a process in which both the software and the hardware are combined. The process performed by the information processing apparatus 12 may be stored in a storage medium as a program and distributed.

In addition, the present disclosure is not limited to the above description, and various modifications other than the above description may be made without departing from the gist thereof.

Regarding the above exemplary embodiment, the following supplementary notes are further disclosed.

(((1)))

An information processing system comprising:
a processor configured to:
   accept a search query;
   acquire file data, which is a search result, by searching a database by using the search query;
   generate an outline of the file data by using the search query or metadata manually added in advance to the file data; and
   display the outline of the file data on a display unit.
      (((2)))

The information processing system according to (((1))), wherein the processor is configured to:
generate the outline of the file data by using the search query and the metadata.
   (((3)))

The information processing system according to (((1))) or (((2))),
wherein the metadata includes person data related to the file data, and
the processor is configured to:
   in a case of generating the outline of the file data by using the metadata, generate the outline of the file data by using the person data.
      (((4)))

The information processing system according to (((3))), wherein the processor is configured to:
in a case of generating the outline of the file data by using the person data, generate the outline of the file data by using organization data to which a person represented by the person data belongs.
   (((5)))

The information processing system according to (((4))), wherein the processor is configured to:
in a case of generating the outline of the file data by using the organization data, generate the outline of the file data by using a relationship between a search user who inputs the search query and the person data.
   (((6)))

The information processing system according to any one of (((1))) to (((5))), wherein the processor is configured to:
generate the outline of the file data by using the search query with priority over the metadata.
   (((7)))

The information processing system according to (((6))),
wherein the metadata is first metadata manually added in advance,
the file data is added with second metadata which is automatically added, and
the processor is configured to:
   generate the outline of the file data by using the search query with priority over the first metadata and the second metadata; and
   generate the outline of the file data by using the first metadata with priority over the second metadata.
      (((8)))

The information processing system according to (((7))),
wherein the first metadata is added with identification data of a user who adds the first metadata to the file data, and
the processor is configured to:
   in a case where the identification data added to the first metadata represents a search user who inputs the search query, generate the outline of the file data by using the first metadata added by the search user with priority over the first metadata added by a user different from the search user.
      (((9)))

The information processing system according to any one of (((1))) to (((8))),
wherein the search query is a first search query, and
the processor is configured to:
   generate the outline of the file data by using a second search query which is a search query used in past by a search user who inputs the first search query and is classified into a group corresponding to the first search query.
      (((10)))

An information processing program causing a computer to execute a process comprising:
accepting a search query;
acquiring file data, which is a search result, by searching a database by using the search query;
generating an outline of the file data by using the search query or metadata manually added in advance to the file data; and
displaying the outline of the file data on a display unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
accept a search query;
acquire file data, which is a search result, by searching a database by using the search query;
generate an outline of the file data by using the search query or metadata manually added in advance to the file data; and
display the outline of the file data on a display unit.

2. The information processing system according to claim 1, wherein the processor is configured to:
generate the outline of the file data by using the search query and the metadata.

3. The information processing system according to claim 1,
wherein the metadata includes person data related to the file data, and
the processor is configured to:
in a case of generating the outline of the file data by using the metadata, generate the outline of the file data by using the person data.

4. The information processing system according to claim 3, wherein the processor is configured to:
in a case of generating the outline of the file data by using the person data, generate the outline of the file data by using organization data to which a person represented by the person data belongs.

5. The information processing system according to claim 4, wherein the processor is configured to:
in a case of generating the outline of the file data by using the organization data, generate the outline of the file data by using a relationship between a search user who inputs the search query and the person data.

6. The information processing system according to claim 1, wherein the processor is configured to:
generate the outline of the file data by using the search query with priority over the metadata.

7. The information processing system according to claim 6,
wherein the metadata is first metadata manually added in advance,
the file data is added with second metadata which is automatically added, and
the processor is configured to:
generate the outline of the file data by using the search query with priority over the first metadata and the second metadata; and
generate the outline of the file data by using the first metadata with priority over the second metadata.

8. The information processing system according to claim 7,
wherein the first metadata is added with identification data of a user who adds the first metadata to the file data, and
the processor is configured to:
in a case where the identification data added to the first metadata represents a search user who inputs the search query, generate the outline of the file data by using the first metadata added by the search user with priority over the first metadata added by a user different from the search user.

9. The information processing system according to claim 1,
wherein the search query is a first search query, and
the processor is configured to:
generate the outline of the file data by using a second search query which is a search query used in past by a search user who inputs the first search query and is classified into a group corresponding to the first search query.

10. A non-transitory computer readable medium storing an information processing program causing a computer to execute a process comprising:
accepting a search query;
acquiring file data, which is a search result, by searching a database by using the search query;
generating an outline of the file data by using the search query or metadata manually added in advance to the file data; and
displaying the outline of the file data on a display unit.

11. An information processing method comprising:
accepting a search query;
acquiring file data, which is a search result, by searching a database by using the search query;
generating an outline of the file data by using the search query or metadata manually added in advance to the file data; and
displaying the outline of the file data on a display unit.
